(19) United States
(12) Patent Application Publication
(10) Pub. No.: US 2010/0071133 A1
(43) Pub. Date: Mar. 25, 2010

(54) NON-TRAUMATIC ARTICULATED STRETCHER

(75) Inventor: Andrea BERTOZZI, Parma (IT)

Correspondence Address: Pearne & Gordon LLP, 1801 East 9th Street, Suite 1200, Cleveland, OH, 44114-3108, US

(73) Assignee: ME.BER. S.R.L., 43010 Parma (IT)

(21) Appl. No.: 12/563,908

(22) Filed: Sep. 21, 2009

(30) Foreign Application Priority Data
Sep. 23, 2008 (IT) PR2008A000056

(51) Int. Cl. A61G 1/013

(52) U.S. Cl. 5/627

(57) ABSTRACT

Non-traumatic articulated stretcher (1) comprising:
a section (2) for housing a user along a longitudinal axis (3);
means (4) for activating the stretcher (1) including means (6) for articulating the stretcher (1) that are operatively active on the housing section (2) to modify its operative conformation for supporting an outstretched user by varying the mutual orientation of two portions (7) of the housing section (2) connected by the articulating means (6), said articulating means (6) being off-centre with respect to the longitudinal axis (3) to facilitate the recovery of the user.

The present invention has for its subject a non-traumatic articulated stretcher, in particular for use in the medical emergency sector.

As is well-known, there exist various types of stretchers, differentiated on the basis of their use. For example, so-called “scoop” stretchers are typically used in first-aid operations for non-traumatic recovery of patients. Such stretchers do not also constitute an immobilisation device once recovery has been effected, unlike stretchers of “spinal” type, which do constitute a device for recovery and immobilisation. There are also self-loading stretchers, paediatric stretchers and folding and non-folding chair stretchers.

The stretchers available on the market have an area for housing the patient in an outstretched position, and means of movement. For example, scoop stretchers are known with a frame in aluminium or aluminium alloys, and length adjustable according to the height of the user. Such stretchers have longitudinal symmetry, with grips arranged perimetrally to the stretcher itself.

The principal disadvantage of the currently known solutions is connected with the difficulty of using them in uncomfortable situations, particularly in narrow spaces or where the supporting surfaces are not planar.

Another disadvantage of known stretchers lies in the instability of the stretcher during transport of the patient in particularly difficult situations.

A further disadvantage of the stretchers on the market concerns the high cost and time taken for repairing stretchers. Often, furthermore, in the case of damage to certain parts, it is necessary to replace the stretcher completely.

Another disadvantage of the known art relates to the stretchers' lack of comfort. The patient, in fact, lies outstretched directly on the frame, which is made of metal and therefore rigid, and as a result is hard and uncomfortable.

A further disadvantage of the stretchers on the market lies in the difficulty of logistical management of the stretchers themselves.

In this context, the technical task at the root of the present invention is to propose a non-traumatic articulated stretcher which overcomes the disadvantages of the known art mentioned above.

In particular, it is an object of the present invention to make available a non-traumatic articulated stretcher which is easily adaptable for use in uncomfortable situations, particularly in narrow spaces or where the supporting surfaces are not planar.

A further object of the present invention is to propose a non-traumatic articulated stretcher with a high degree of stability while the patient is being transported in particularly difficult situations.

Another object of the present invention is to propose a non-traumatic articulated stretcher which, in the event of damage, is repairable in a short time and at moderate cost.

A further object of the present invention is to make available a non-traumatic articulated stretcher which is ergonomic both for the user and for the health personnel.

Another object of the present invention is to propose a non-traumatic articulated stretcher which is easily manageable from a logistical point of view.

The declared technical task and the specified objects are substantially achieved by a non-traumatic articulated stretcher comprising the technical characteristics set forth in one or more of the attached claims.

Further characteristics and advantages of the present invention will become clearer from the indicative, and therefore non-limiting, description of a preferred but not exclusive embodiment of a non-traumatic articulated stretcher, as illustrated in the attached drawings, in which:

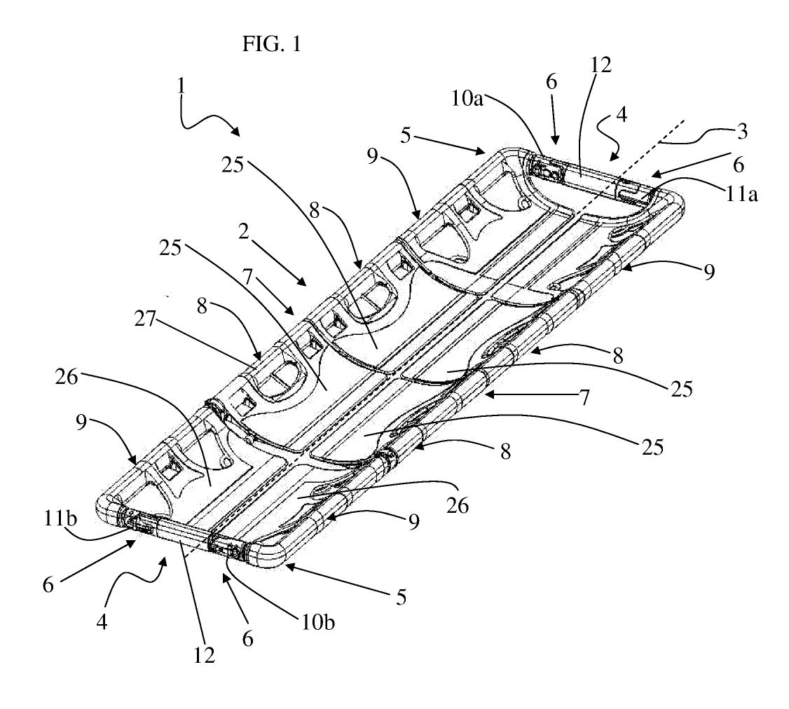

FIG. 1 illustrates a non-traumatic articulated stretcher, according to the present invention, in a perspective view;

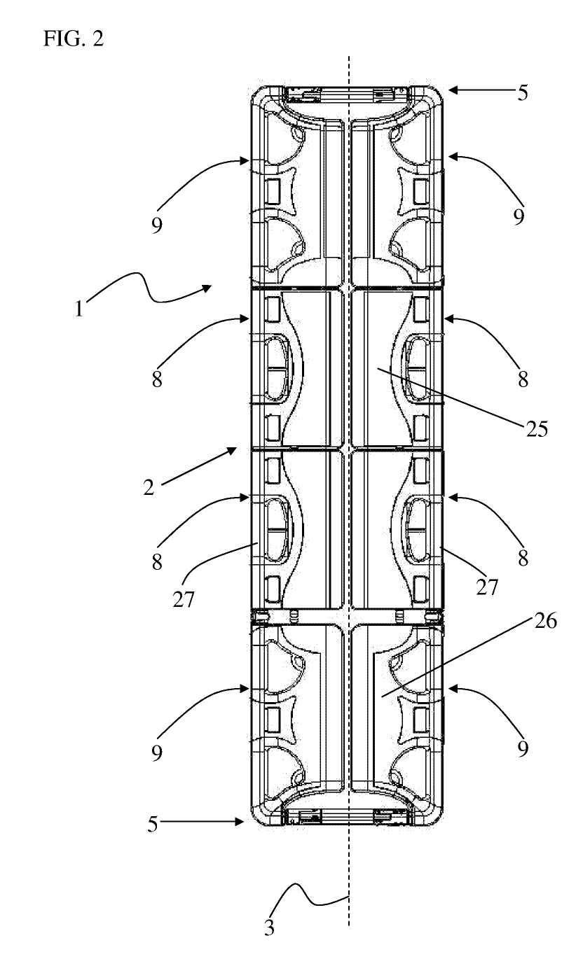

FIG. 2 illustrates the stretcher of FIG. 1, in a top view;

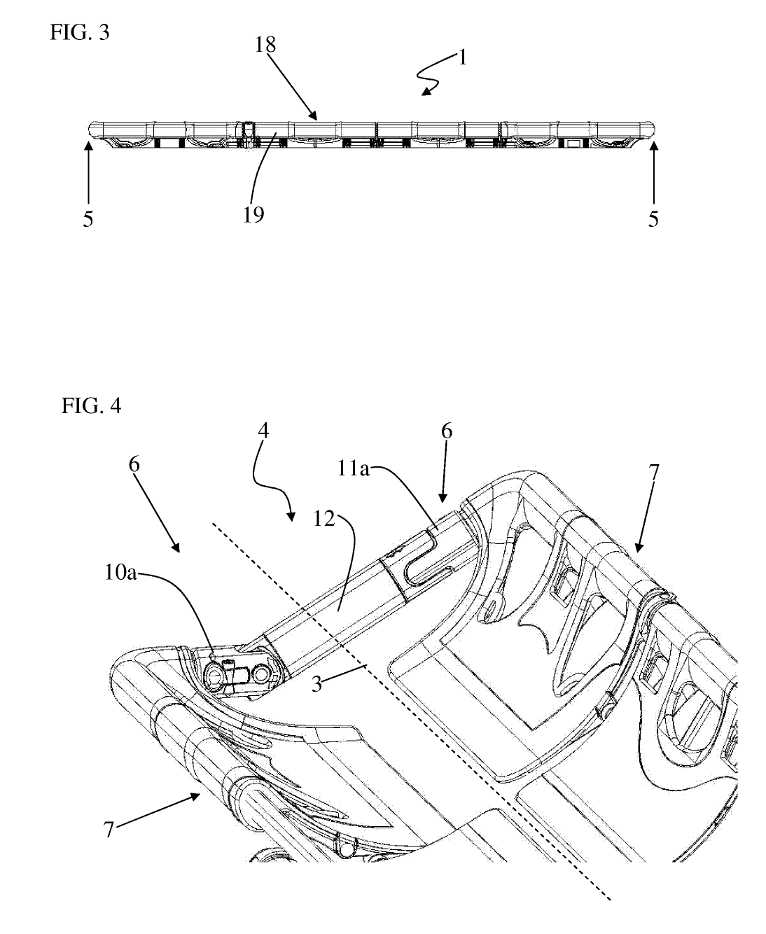

FIG. 3 illustrates the stretcher of FIG. 1, in a side view;

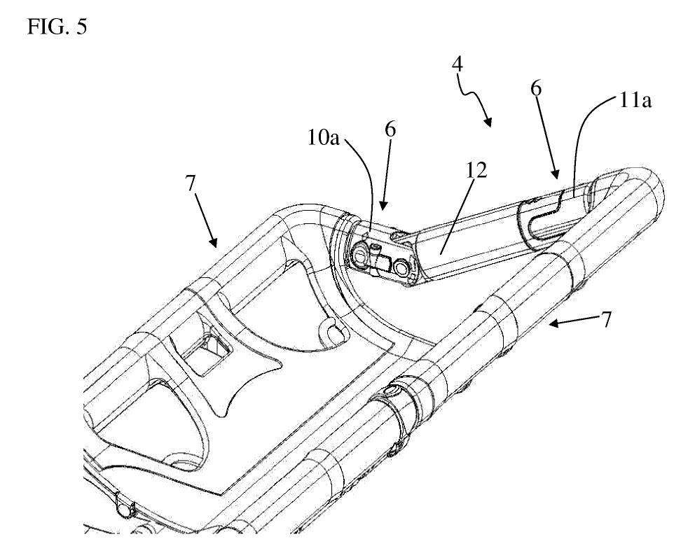

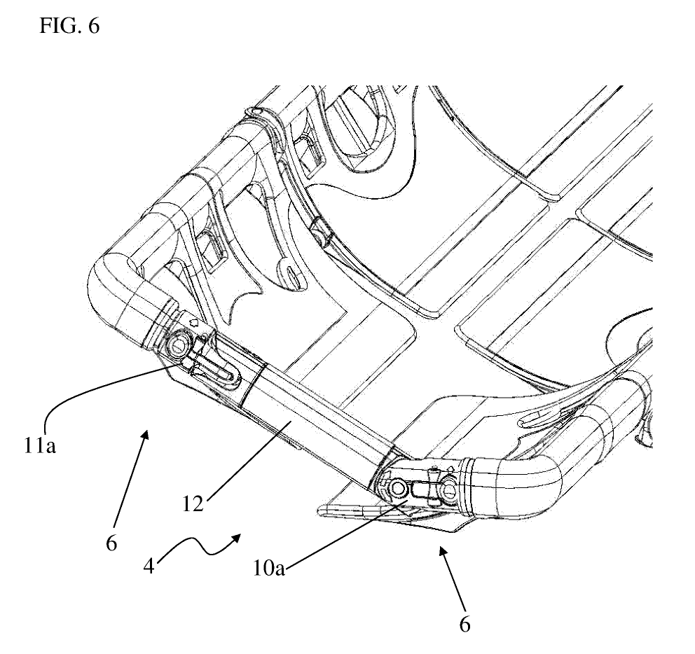

FIGS. 4, 5 and 6 illustrate details of the stretcher of FIG. 1, in three perspective views.

With reference to the figures, no. 1 indicates a non-traumatic articulated stretcher, in particular for use in the medical emergency sector. For example, such a stretcher 1 is used for the recovery of a user in first aid operations and as an immobilisation device. Alternatively, stretcher 1 can be of “spinal” type. The stretcher 1 comprises a section 2 for housing the user along a longitudinal axis 3. In particular, the user lies outstretched along this longitudinal axis 3. The stretcher 1 is furthermore provided with means 4 for activating the stretcher 1 that are located at two opposed ends 5 of the housing section 2.

Originally, the means 4 for activating the stretcher 1 include means 6 for articulating the stretcher 1. Advantageously, these means 6 for articulating the stretcher 1 are operatively active on the housing section 2 to modify its operative conformation for supporting an outstretched user by varying the mutual orientation of two portions 7 (or half-shells) of the housing section 2, connected by the means 6 for articulating the stretcher 1. Preferably, such portions 7 of housing section 2 are symmetrical with respect to the longitudinal axis 3 and have planar extension. In particular, the planes identified by said portions 7 intersect at the longitudinal axis 3 and thus form an angle. The means 6 for articulating the stretcher 1 allow the angle to be varied in such a way as to adapt the stretcher 1 to various recovery situations.

Advantageously, the housing section 2 is made up of a plurality of identical central modules 8 and of two outer modules 9 which, too, are identical. In particular, these outer modules 9 house the means 4 for activating the stretcher 1. Preferably, there are two of the central modules 8, each formed of two central submodules 25, in such a way as to house respectively the lumbar and dorsal areas. The external modules 9, each formed of two external submodules 26, house respectively the cervical area and the feet.

Originally, the means 6 for articulating the stretcher 1 comprise a first articulated element 10a and a second articulated element 10b for mutually inclining the two portions 7 of the housing section 2 in a desired configuration. In particular, this desired configuration corresponds to a predetermined value for the angle formed by the planes comprising the portions 7.

Originally, the means 6 for articulating the stretcher 1 also comprise a first locking element 11a and a second locking element 11b in order to lock the portions 7 into the desired configuration. In particular, said portions 7 are locked in such a way that the predetermined value for the angle formed by the planes comprising the portions 7 is maintained.

Originally, the means 6 for articulating the stretcher 1 are off-centre with respect to the longitudinal axis 3 in order to facilitate recovering the user. Advantageously, the first articulated element 10a and first locking element 11a are antisymmetric in relation to the second articulated element 10b and the second locking element 11b with respect to the longitudinal axis 3.

Preferably, the means 4 for activating the stretcher 1 comprise at least two gripping areas 12 for grasping the stretcher 1. Preferably, the two gripping areas 12 are made of soft plastic material to facilitate grasping the stretcher 1. Preferably, the two gripping areas 12 are respectively interposed between the first articulated element 10a and the first locking element 11a, and between the second articulated element 10b and the second locking element 11b. Preferably, the stretcher 1 comprises auxiliary gripping areas 27 located perimetrally to the stretcher 1 and parallel to the longitudinal axis 3.

The stretcher 1 has a frame 18, preferably made of metal. More preferably, the frame 18 is made of a non-magnetic metallic material, for example of aluminium or aluminium alloy. For example, the frame 18 is made up of tubular sections 19 of known type.

Originally, the frame 18 has applied to it a first layer of rigid plastic material to structurally shape the stretcher 1. Preferably, the first layer is made of heat-resistant material. More preferably, this first layer is made of thermoplastic polymer, for example of POLIFOR.

Originally, the first layer has applied to it a second layer of soft plastic material so as to promote the comfort of the user supported on the stretcher 1. Preferably, the second layer is made of heat-resistant material. More preferably, this second layer is made of thermoplastic elastomer, for example of FORPRENE.

Preferably, the two gripping areas 12 and the auxiliary gripping areas 27 are located on the second layer.

Advantageously, the stretcher 1 is provided with a radio frequency identification device (commonly known by the acronym RFID, from the English “Radio Frequency Identification”). Preferably, the radio frequency identification device is a passive electronic circuit. In particular, the radio frequency identification device is used for communicating identification parameters of the stretcher 1. For example, these identification parameters comprise the times and dates of entry and exit of the stretcher 1 from the hospital departments, the batch to which it belongs and the date of purchase of the stretcher 1 and the date specified for the next maintenance of the stretcher 1 itself.

Preferably, the stretcher 1 has a thickness of about 5 cm, a width of about 43 cm and a length adjustable in known manner from a minimum of about 165 cm to a maximum of about 201 cm depending on the height of the user. The weight of the stretcher 1 is about 11 kg and its carrying capacity is about 150 kg. Preferably, the stretcher 1 is foldable, and in folded configuration has a length of 120 cm and a thickness of 9 cm.

Preferably, identifying elements can be applied to the stretcher 1. For example, these identifying elements consist of adhesive labels attached to lowered areas of the stretcher 1. In particular, these adhesive labels carry the manufacturer's trademark and the name under which the stretcher 1 is sold. Alternatively or in addition, these adhesive labels carry the mark of the health institution to which the stretcher 1 belongs. Alternatively or in addition, these adhesive labels carry advertising information, for example for pharmaceutical products. Alternatively or in addition, the adhesive labels can carry the names of the individual people or of the organisations which donated the stretcher 1.

Preferably, the first layer and the second layer have customisable colours which facilitate the further identification of the stretcher 1. For example, different colours can indicate different departments of the same health institution to which the stretcher 1 belongs.

The user is held in the stretcher 1 by means of restraining belts of known type.

The operation of the non-traumatic articulated stretcher, according to the present invention, is described below. In operations to recover the user, for example in first aid, a stretcher 1 for example of “scoop” type is used. The stretcher 1 is lifted and transported into proximity with the user by grasping the gripping areas 12 and the auxiliary gripping areas 27. The length of the stretcher 1 is adjusted according to the height of the user to be recovered.

To adapt to different recovery situations (narrow spaces, shape of the supporting surface etc.), an operator acts on the first articulated element 10a and on the second articulated element 10b, so as to incline the portions 7 in the desired configuration. The weight of the patient on the housing section 2 activates the first locking element 11a and the second locking element 11b in such a way that the portions 7 remain locked in the desired configuration. In this way, the user can be transported in a non-traumatic manner to the health institution, and the stretcher 1 can function also as an immobilisation device after administration of first aid. The characteristics of the non-traumatic articulated stretcher according to the present invention are clear from the description given above, as also are the advantages.

In particular, thanks to the presence of the means for articulating the stretcher which allow the mutual orientation of the two portions of the housing section to be varied, the stretcher is easily adaptable for use in uncomfortable situations, particularly in narrow spaces or where the supporting surfaces are not planar. In this way, movements of the spinal column are minimised.

In addition, because the means for articulating the stretcher are off-centre with respect to the longitudinal axis, the stretcher retains stability even in the recovery and transport of the user in particularly difficult situations. This advantage is strengthened by the antisymmetric configuration of the first articulated element and the first locking element in relation to the second articulated element and the second locking element.

Moreover, in the event of damage, the stretcher is easily repairable. It is actually possible to replace just the damaged submodules (central or external), thus reducing the cost and the time taken by comparison with stretchers currently on the market.

Besides this, the stretcher is made up of rigid and soft materials which make the user's time on the stretcher itself more comfortable. This layered structure of the stretcher also allows it to be used as an immobilisation as well as a recovery device, ensuring good ergonomics for the user.

Moreover, because the gripping areas are made of soft plastic material, the stretcher is ergonomic for the health personnel as well.

Finally, the presence of the radio frequency identification device and the customisation of the colours of the first and second layers facilitate managing the logistics of the stretcher.

1. Non-traumatic articulated stretcher comprising:
a section for housing a user along a longitudinal axis;
means for activating the stretcher located at two opposed ends of the housing section,
wherein said means for activating the stretcher include means for articulating the stretcher that are operatively active on the housing section to modify its operative conformation for supporting an outstretched user by varying the mutual orientation of two portions of the housing section connected by the means for articulating the stretcher.

2. Stretcher according to claim 1, wherein the means for activating the stretcher include furthermore at least two gripping areas for grasping the stretcher.

3. Stretcher according to claim 1, wherein said means for articulating the stretcher include a first articulated element and a second articulated element for mutually inclining the two portions of the housing section in a desired configuration, and a first locking element and a second locking element for holding said portions in said desired configuration.

4. Stretcher according to claim 2, wherein said means for articulating the stretcher include a first articulated element and a second articulated element for mutually inclining the two portions of the housing section in a desired configuration, and a first locking element and a second locking element for holding said portions in said desired configuration.

5. Stretcher according to claim 4, wherein the first articulated element and the first locking element are antisymmetric in relation to the second articulated element and the second locking element with respect to the longitudinal axis.

6. Stretcher according to claim 5, wherein said at least two gripping areas are respectively interposed between the first articulated element and the first locking element and between the second articulated element and the second locking element.

7. Stretcher according to claim 1, wherein the housing section is made up of a plurality of identical central modules and two outer modules housing the means for activating the stretcher.

8. Stretcher according to claim 1, characterised in that the stretcher includes a frame made of metallic material onto which is applied a first layer of rigid plastic material which in its turn undergoes the application of a second layer of soft plastic material to favour the supporting comfort of the outstretched user.

9. Stretcher according to claim 1, including furthermore a radiofrequency identifying device for communicating identifying parameters of the stretcher.

10. Stretcher according to claim 1, wherein the portions of the housing section have planar extension.

11. Stretcher according to claim 2, wherein said gripping areas are made of soft plastic material to favour the gripping of the stretcher.

12. Stretcher according claim 1, wherein said means for articulating the stretcher are off-centre with respect to the longitudinal axis to facilitate recovering the user.
